(19) United States
(12) Patent Application Publication
(10) Pub. No.: US 2011/0043324 A1
(43) Pub. Date: Feb. 24, 2011

(54) LOCKING SYSTEM AND METHOD FOR ELECTRONIC DEVICE

(75) Inventor: CHAO-TSUNG FAN, Tu-Cheng (TW)

Correspondence Address: Altis Law Group, Inc.;ATTN: Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/606,202

(22) Filed: Oct. 27, 2009

(30) Foreign Application Priority Data
Aug. 20, 2009 (CN) 200910305856.9

(51) Int. Cl. G06F 7/04

(52) U.S. Cl. 340/5.1

(57) ABSTRACT

A locking system includes a radio frequency identification (RFID) tag encoded with a first code, an antenna, an RFID reader, a storage unit storing a second code, and a microprocessor. The RFID reader receives a radio-frequency signal emitted from the RFID tag via the antenna. The radio-frequency signal includes identification of the first code. The microprocessor compares the first code and the second code, and locks an electronic device when the first code does not match the second code.

### BACKGROUND

1. Technical Field

The present disclosure relates to a locking system and a locking method for an electronic device.

2. Description of Related Art

Nowadays, electronic devices, such as digital video disk (DVD) players, are widely used in vehicles for entertainment. However, because of small size of the DVD player, it may be stolen when the owner is left the vehicle.

### BRIEF DESCRIPTION OF THE DRAWINGS

FIG. 1 is a schematic diagram of an exemplary embodiment of a locking system for an electronic device.

FIG. 2 is a flowchart of an exemplary embodiment of a locking method for an electronic device.

### DETAILED DESCRIPTION

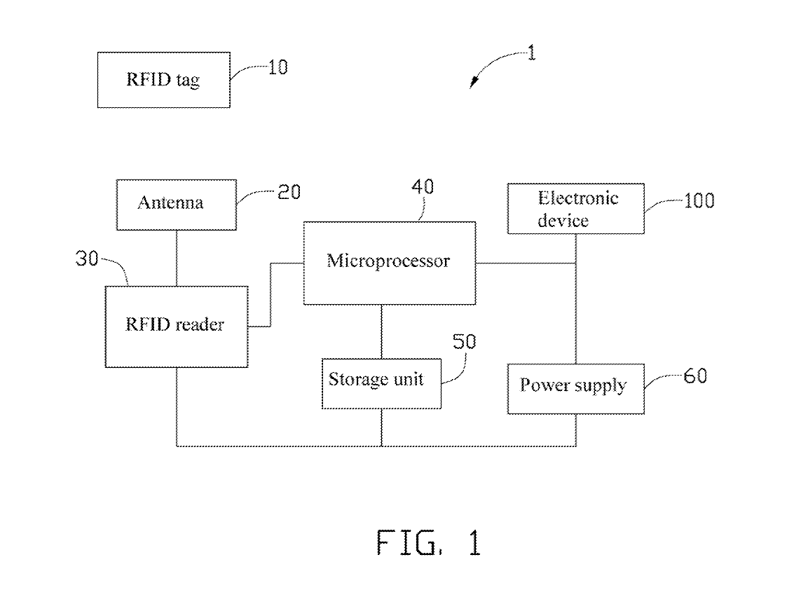

Referring to FIG. 1, an exemplary embodiment of a locking system 1 includes a radio frequency identification (RFID) tag 10, an antenna 20, an RFID reader 30, a microprocessor 40, a storage unit 50, and a power supply 60. The locking system 1 is used in an electronic device 100, such as a digital video disk (DVD) player, for locking the electronic device 100 when the electronic device 100 is stolen. It can be understood that the electronic device 100 being locked means that the electronic device 100 is deactivated.

The antenna 20, the RFID reader 30, the microprocessor 40, and the storage unit 50 are mounted in the electronic device 100. The RFID tag 10 is retained by an owner of the electronic device 100.

The power supply 60 is connected to the RFID reader 30, the microprocessor 40, the storage unit 50, and the electronic device 100, providing power thereto.

The RFID reader 30 is connected to the antenna 20, for receiving a radio-frequency signal emitted from the RFID tag 10 via the antenna 20. The RFID reader 30 is also connected to the microprocessor 40, for transmitting the radio-frequency signal to the microprocessor 40. The RFID tag 10 is encoded with a first code. The radio-frequency signal includes identification of the first code of the RFID tag 10.

The microprocessor 40 is also connected to the storage unit 50 for reading a second code stored in the storage unit 50. The microprocessor 40 also compares the first code with the second code, and controls the electronic device 100 according to a comparing result. On the condition that the first code matches the second code, the microprocessor 40 activates the electronic device 100. By contrast, on the condition that the first code does not match the second code, the microprocessor 40 deactivates the electronic device 100. It can be understood that the first code matching the second code means that the first code is the same as the second code. The microprocessor 40 deactivating the electronic device 100 means that the microprocessor 40 disables the electronic device 100.

In use, the second code stored in the storage unit 50 can be set to the first code of the RFID tag 10. When the electronic device 100 is separated from the RFID tag 10, the electronic device 100 becomes locked, and cannot be operated.

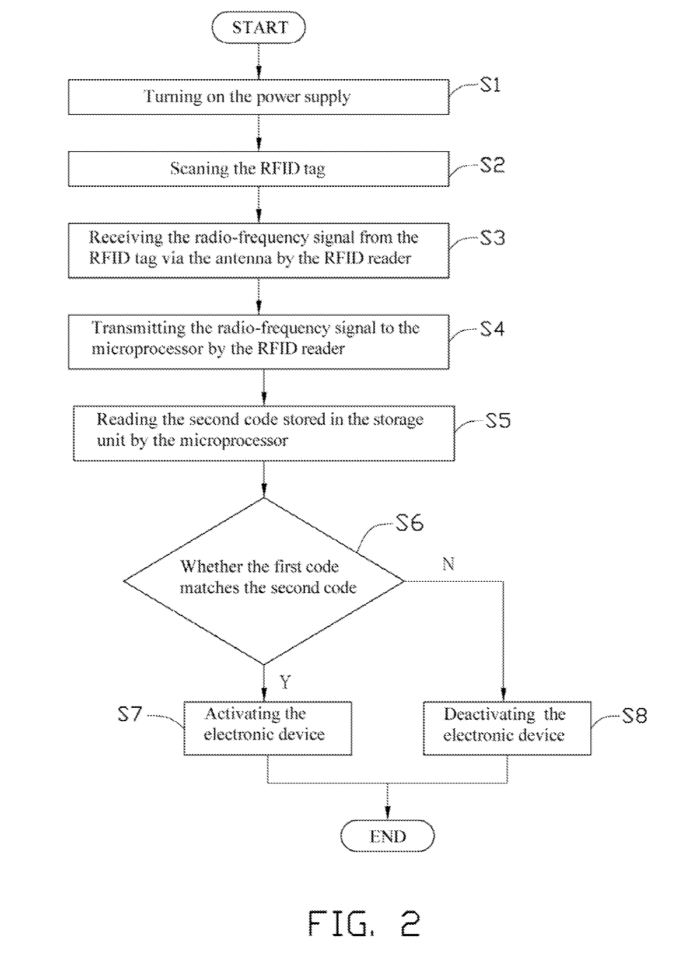

Referring to FIG. 2, an exemplary embodiment of a locking method includes following steps.

In step S1, the power supply 60 is turned on.

In step S2, the antenna 20 scans the RFID tag 10.

In step S3, the RFID reader 30 receives the radio-frequency signal from the RFID tag 10 via the antenna 20. The radio-frequency signal includes identification of the first code corresponding to the RFID tag 10.

In step S4, the RFID reader 30 transmits the radio-frequency signal to the microprocessor 40.

In step S5, the microprocessor 40 reads the second code stored in the storage unit 50.

In step S6, the microprocessor 40 compares the first code with the second code. On the condition that the first code matches the second code, step S7 is implemented. On the condition that the first code does not match the second code, step S8 is implemented.

In step S7, the microprocessor 40 activates the electronic device 100.

In step S8, the microprocessor 40 deactivates the electronic device 100.

The foregoing description of the exemplary embodiments of the disclosure has been presented only for the purposes of illustration and description and is not intended to be exhaustive or to limit the disclosure to the precise forms disclosed. Many modifications and variations are possible in light of the above everything. The embodiments were chosen and described in order to explain the principles of the disclosure and their practical application so as to enable others of ordinary skill in the art to utilize the disclosure and various embodiments and with various modifications as are suited to the particular use contemplated. Alternative embodiments will become apparent to those of ordinary skills in the art to which the present disclosure pertains without departing from its spirit and scope. Accordingly, the scope of the present disclosure is defined by the appended claims rather than the foregoing description and the exemplary embodiments described therein.

What is claimed is:

1. A locking system comprising:
a radio frequency identification (RFID) tag encoded with a first code;
an antenna;
an RFID reader receiving a radio-frequency signal emitting from the RFID tag via the antenna, wherein the radio-frequency signal comprises information of the first code;
a storage unit to store a second code; and
a microprocessor to compare the first code and the second code, and controls an electronic device according to a comparing result between the first and second codes.

2. The locking system of claim 1, wherein the antenna, the RFID reader, the microprocessor, and the storage unit are mounted in the electronic device.

3. The locking system of claim 1, wherein the RFID reader, the microprocessor, and the storage unit are connected to a power supply unit.

4. The locking system of claim 1, wherein on the condition that the first code matches the second code, the microprocessor activates the electronic device.

5. Te locking system of claim 4, wherein that the first code matches the second code means that the first code is the same as the second code.

6. The locking system of claim 1, wherein on the condition that the first code does not match the second code, the microprocessor deactivates the electronic device.

7. The locking system of claim 6, wherein that the first code does not match the second code means that the first code is different from the second code.

8. A locking method comprising:
an antenna scanning a radio frequency identification (RFID) tag encoded with a first code;
a RFID reader receiving a radio-frequency signal emitted from the RFID tag via the antenna, wherein the radio-frequency signal comprises identification of the first code;
transmitting the radio-frequency signal to a microprocessor;
reading a second code by the microprocessor;
comparing the first code and the second code by the microprocessor; and
controlling an electronic device according to a comparing result between the first and second codes.

9. The locking method of claim 8, wherein controlling the electronic device comprises:
on the condition that the first code matches the second code, the microprocessor activates the electronic device.

10. The locking method of claim 8, wherein controlling the electronic device comprises:
on the condition that the first code does not match the second code, the microprocessor deactivates the electronic device.
